(19) United States
(12) Patent Application Publication
(10) Pub. No.: US 2019/0152082 A1
(43) Pub. Date: May 23, 2019

(54) MACHINE FOR CUTTING VEGETABLES INTO LINES

(71) Applicant: Turatti S.R.L., Venezia (IT)

(72) Inventor: Antonio TURATTI, Venezia (IT)

(73) Assignee: Turatti S.R.L., Venezia (IT)

(21) Appl. No.: 16/300,070

(22) PCT Filed: May 8, 2017
(86) PCT No.: PCT/IT2017/000096

§ 371 Date: Nov. 9, 2018

(30) Foreign Application Priority Data
May 9, 2016 (IT) 102016000047089

(51) Int. Cl. B26D 3/16; B26D 1/29; B26D 3/22; B26D 7/06

(52) U.S. Cl. CPC B26D 3/16; B26D 1/29; B26D 3/22; B26D 2001/0033; B26D 7/0625; B26D 7/0683; B26D 7/0608

(57) ABSTRACT

The invention concerns a machine for cutting vegetables into different shapes lines, said machine comprising:
holding means (9) which are configured to receive and hold at least one vegetable;
cutting means (21) for cutting said at least one vegetable into lines, said cutting means (21) being located downstream from said holding means (9); and
thrust means (6) which are movable according to a predetermined direction (S), to push at least one vegetable through said holding means (9) against said cutting means (21);
wherein said thrust means (6), said holding means (9) and said cutting means (21) are substantially aligned along said predetermined direction (S); and
wherein said holding means (9) or said cutting means (21) are respectively movable in rotation relative to said cutting means (21) or said holding means (9), such that said cutting means (21) operate on said at least one vegetable, forming at least one substantially filiform vegetable portion when said thrust means (6) push, when in use, said at least one vegetable against said cutting means (21).

The present invention relates to a machine for cutting vegetable into lines, i.e. a machine capable of extracting filiform portions from a vegetable such as a carrot.

In the following, the description will be directed to a machine to cut a carrot into lines, but it is quite obvious that the same should not be considered limited to this specific use, being it possible using the same for cutting other vegetables such as potatoes or zucchini.

Various machines and devices are known to cut vegetables into lines, however, which having disadvantages and drawbacks of different kinds.

The object of the present invention is to provide a machine for cutting vegetable into lines, which allows obtaining uniform vegetable portions.

Another object of the invention is to provide a machine for cutting vegetable into lines, which has a high productivity rate.

Another object of the present invention is to provide a machine for cutting vegetable into lines, which is safe and reliable in use.

It is therefore specific object of the present invention a mmachine for cutting vegetables into different shapes lines, said machine comprising: holding means which are configured to receive and hold at least one vegetable; cutting means for cutting said at least one vegetable into lines, said cutting means being located downstream from said holding means; and thrust means which are movable according to a predetermined direction, to push at least one vegetable through said holding means against said cutting means; wherein said thrust means, said holding means and said cutting means are substantially aligned along said predetermined direction; and wherein said holding means or said cutting means are respectively movable in rotation relative to said cutting means or said holding means, such that said cutting means operate on said at least one vegetable, forming at least one substantially filiform vegetable portion.

Preferably, according to the invention, said holding means are movable in rotation relative to said cutting means.

Further, according to the invention, said thrust means can comprise a head which is idle rotatable and comprises engaging means configured to engage with said holding means such that said head passes through said holding means and rotates together with said holding means when said holding means rotate.

Advantageously according to the invention, said holding means can comprise centering means to center said at least one vegetable relative to said predetermined direction.

Still according to the invention said machine can comprise orienting means to orient an end portion of said at least one vegetable towards said cutting means.

Advantageously, according to the invention, said orienting means can comprise a plurality of arms which are rotatable and elastic means connected with said plurality of arms such as to push said plurality of arms towards said at least one vegetable when said at least one vegetable is located in said holding means.

Furthermore, according to the invention, a through cavity can be formed in said holding means, the through cavity being directed according to said predetermined direction and configured to receive said at least one vegetable, a plurality of openings can be formed in said holding means, the plurality of openings being in communication with said through cavity, and said holding means can comprise a plurality of holding elements which are movable through said plurality of openings such as to constrain, when in use, said at least one vegetable when said plurality of holding elements is arranged through said plurality of openings.

Still according to the invention, said holding means can comprise elastic means connected with said plurality of holding elements such as to push said plurality of holding elements towards said at least one vegetable when said at least one vegetable is arranged in said holding means.

Advantageously, according to the invention, said machine can comprise a removing element operating between said holding means and said cutting means such as to remove a portion of said at least one vegetable from a zone comprised between said holding means and said cutting means after cutting said at least one vegetable.

Furthermore, according to the invention, said machine can comprise a conveyor belt where a plurality of housings or cups for vegetables is defined, and a lifting system which is configured to operate on at least one portion of said conveyor belt such as to bring at least one vegetable, which is arranged in a housing, in a position defined between said thrust means and said holding means.

Alternatively, according to the invention, said holding means can be fixed and said cutting means can be movable in rotation relative to said holding means.

The present invention will now be described for illustrative illustration but not limitative purposes to one of its preferred embodiments, with particular reference to the figures of the enclosed drawings, wherein:

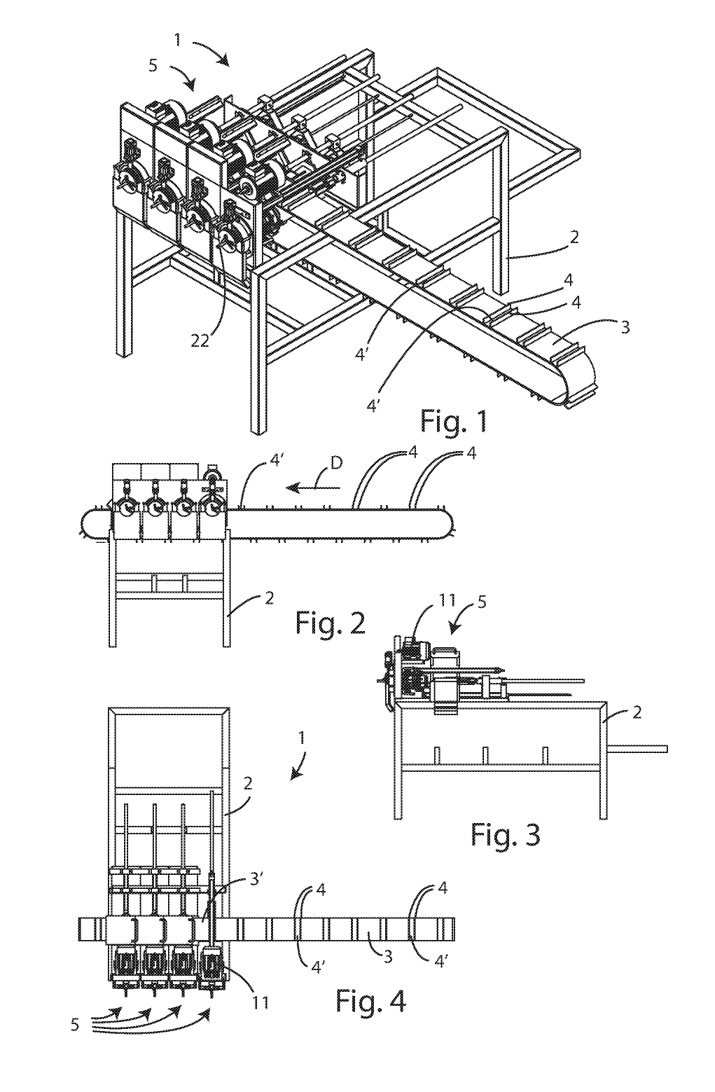

FIG. 1 shows a machine for cutting vegetable into lines according to an embodiment of the present invention;

FIG. 2 is a front view of the machine shown in FIG. 1;

FIG. 3 is a side view of the machine shown in FIGS. 1 and 2;

FIG. 4 is a top plan view of the machine of FIGS. 1 to 3; and

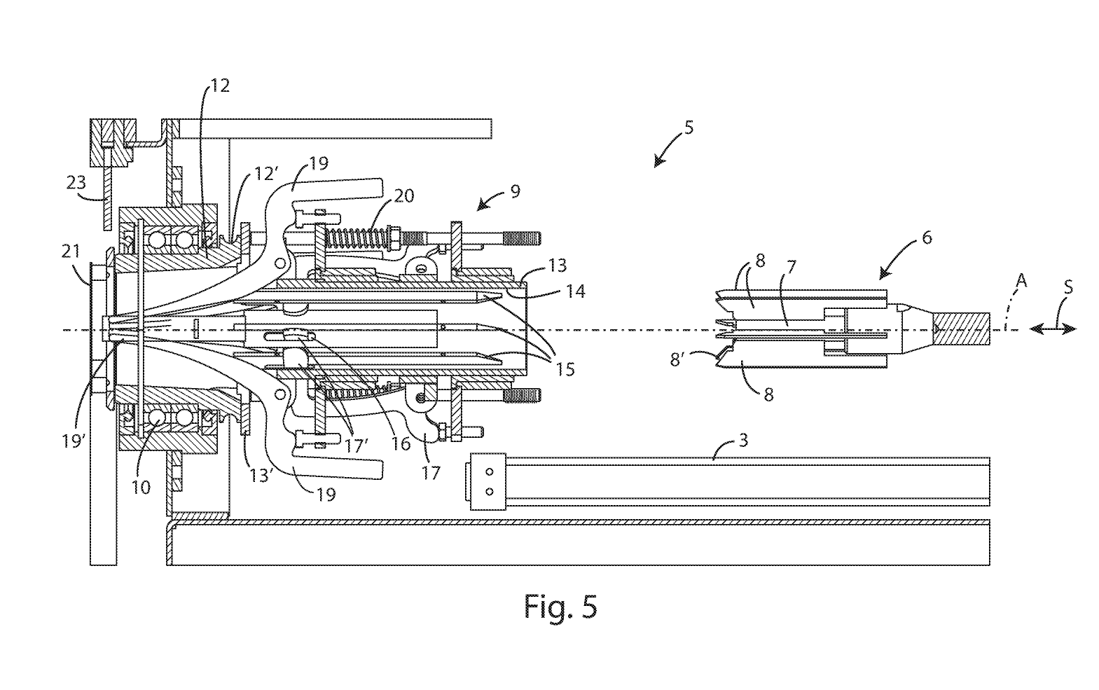

FIG. 5 is a partial sectional view of the machine shown in FIGS. 1 to 3;

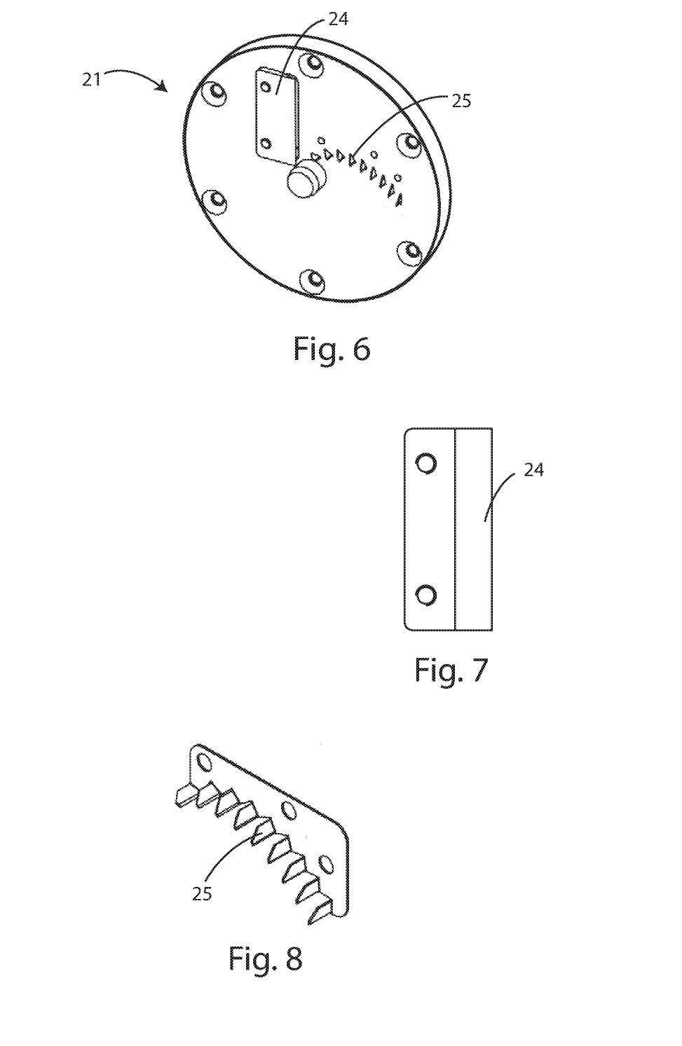

FIG. 6 is a perspective view of a component of the machine shown in FIG. 1;

FIG. 7 shows a detail of the component of FIG. 6; and

FIG. 8 shows another detail of the component shown in FIG. 6.

In the various figures similar parts will be indicated by the same numerical references.

Referring to the enclosed figures, reference number 1 indicates a machine for cutting vegetable into lines.

Machine 1 is comprised of a frame 2 on which it is mounted a conveyor belt 3 connected to a motor for moving it along an advancement direction D.

Conveyor belt 3 externally has a plurality of pairs of protruding reliefs or cups 4 arranged perpendicular to the advancement direction D to form each housing 4′ to accommodate a carrot or other oblong-shaped vegetable such as, for example, an eggplant, a zucchini or a cucumber, etc.

Four operating units 5, arranged mutually adjacent are also mounted on the frame 2, adjacent to a portion 3′ of the conveyor belt 3.

Clearly, according to other arrangements of the machine according to the present invention, operating units 5 may also be provided in a number other than four, even also one single operating unit. Each operating unit 5 comprises thrust means 6 reciprocally movable along a set direction S perpendicular to the advancement direction D of the conveyor belt 3.

At one end of the thrust means 6, a head 7 is rotatably mounted around the axis A of the thrust means 6 and provided with a plurality of radially directed levers 8 and having longitudinal end portions 8′ configured in such a way to realize, jointly, a seat for the lower part of a carrot.

Each operating unit 5 further comprises, along said axis A, holding means 9 for holding the carrot to be cut, mounted on a lateral edge of the conveyor belt 3, frontally with respect to the thrust means 6.

Below said portion 3′ of the conveyor belt 3 it is also provided a lifting system (not shown) able to lift this portion 3′ until the carrots disposed in the housings 4′ are at the same height as the thrust members 6 and holding means 9.

As explained in more detail in the following, the provision of said lifting system in particular allows reducing operating times for feeding of carrots.

The gripping assembly 9 is mounted on the frame 2 swivelling around the axis A through the bearings 10.

Each holding means 9 is rotated by a dedicated electric motor 11 connected to said holding means 9 by means of a transmission belt (not shown) wound in a corresponding groove 12′ obtained in a circumferential portion of the same holding means 9.

Specifically, each holding means 9 comprises a first connection sleeve 12 rotatably connected around the axis A to the frame 2 by means of the aforementioned bearings 10 and a second driving sleeve 13 rigidly coupled to the first connection sleeve 12 by means of an interconnection flange 13′.

Within the second driving sleeve 13 is defined a longitudinal cavity 14. In the inner wall of the second driving sleeve 13 there are a plurality of longitudinal ribs 15 arranged substantially equidistant each other. In the second driving sleeve 13 it is also obtained a plurality of slits 16, provided on a circumferential region of the same sleeve 13 and offset with respect to said plurality of longitudinal ribs 15.

On the second driving sleeve 13 there are mounted a plurality of lever members 17 hinged on the outer wall of the same sleeve 13 and having respective end portions 17′ directed towards the longitudinal cavity 14 and facing each of a slit 16.

As detailed below in the following description, these lever members 17, in cooperation with the longitudinal ribs 15, allow for centring and grasping the carrot into the longitudinal cavity 14 of the second driving sleeve 13.

Externally with respect to the second driving sleeve 13 there is further provided a plurality of spring members acting on said plurality of lever members 17 so as to push the respective end portions 17′ through the slits 16 to occupy the longitudinal cavity 14.

A plurality of guide arms 19 are provided on the front of the second driving sleeve 13, having respective curved front portions 19 cooperating each other so as to direct the carrot tip towards a predetermined cutting zone.

Guide arms 19 are also hinged on the outer wall of the second driving sleeve 13, also interacting with a plurality of spring members 20 configured so as to push said front portions 19′ inwards, bringing them closer each other.

Each operating unit 5 further comprises a cutting member 21 rigidly mounted on the frame 2 and disposed in front of the front portions 19′ of the guide arms 19, i.e. on the opposite part of the thrust member 6.

The cutting member 21 includes, in particular, a straight blade 24, namely a substantially straight cut cutter, for operating spiral cuts on the carrot and a plurality of protruding cutting elements 25 spaced apart each other according to an arc trajectory to produce a series of circular cuts on the outer surface of the same carrot.

Each operating unit 5 also includes an exhaust pipe 22, directed along the axis A and disposed downstream of the cutting member 21.

The above-mentioned exhaust pipe 22 allows, in particular, to drive off the central portion of the carrot from the cutting zone which is progressively formed during cutting of the same carrot.

Also, in correspondence of the space between the cutting member 21 and the tips of the front portions 19′of the guide arms 19, there is provided, in a high position, a guillotine operating removing element 23 to remove from the operating unit 5 the bottom portion of the carrot wasted from the cutting operations.

At the outlet of said exhaust pipe and below the cutting member 21 there are containers or conveyor belts (not shown) respectively for the collection of filiform carrot portions and of the waste portions of the processed carrots.

The operation of the machine 1 described above is carried out in the manner indicated below.

First of all, carrots have to be placed in the housings 4′ located in the conveyor belt 3.

Once the conveyor belt 3 has carried the housings 4′ with the respective carrots in correspondence of the four operating units 5, the above lifting system comes into operation, bringing the carrots to the same height of the thrust members 6.

Now, each thrust member 6 is advanced along said predetermined direction S until the carrot is introduced into the longitudinal cavity 14 of the respective second driving sleeve 13, rotated before around the axis A by the dedicated electric motor 11.

The carrot, entering into the longitudinal cavity 14, also begins to rotate together with the second driving sleeve 13, remaining constantly centred with respect to the axis A, thanks to the double bonding and centring action exerted on the outer surface of the carrot itself by the end portions 17′ of the lever members 17.

Further, when the thrust member 6 in its advancing motion towards the second driving sleeve 13 also enters into the longitudinal cavity 14 along with the carrot, the tabs 8 of the head 7 engage, in opposition, with the ribs longitudinal grooves 15, so that the head 7 also rotates along with the second driving sleeve 13 and at the same time permits the thrust member 6 to advance further by pushing the carrot progressively towards the cutting member 21, thanks to the orientation action of the carrot tip made by the guide arms 19.

The carrot is therefore continually pushed by the thrust member 6 against the cutting member 21 which, thanks to the two cutting action performed by the straight blade 24 and the projecting cutting elements 25, operates on the tip of the same carrot so as to extract from the same, progressively, a filiform portion from its outer surface.

Further, when the thrust member 6 reaches its forward travel stroke towards the cutting member 21 with the respective head 7 out of the front portions 19′ of the guide arms 19, it returns back to its retracted position, leaving a part of the carrot waste between the cutting member 21 and the ends of said front portions 19′

Now, the evacuation member 23 comes into operation, which, when lowered, drops this carrot waste downward, where a conveyor belt or a container for its collection is located.

Once the thrust member 6 is returned to its retracted position, a new feeding and cutting cycle of another carrot begins, according to the same modes described in the above.

According to a further embodiment of the present invention not shown in the enclosed figures, the holding assembly 9 can be fixed and instead the cutting member 21 can rotate around the axis A.

The machine according to the present invention therefore allows for a high level of automation, significantly reducing the operating times for the production of line portions from the selected vegetables for processing.

As to the advantages of the machine described in the above, it is also noted that the qualitative results obtainable with the use of this machine, in terms of uniformity of the filiform portions of the vegetables, are to be considered undoubtedly satisfactory and, in any case, superior with respect to those normally obtainable with traditional technologies.

The present invention has been described for exemplificative, but not limitative purposes, according to its preferred embodiments, but it is to be understood that variations and/or modifications may be made by the those skilled in the art without departing from the scope as defined in the enclosed claims.

In the claims:

1. Machine for cutting vegetables into different shapes lines, said machine comprising:
holding means (9) which are configured to receive and hold at least one vegetable;
cutting means (21) for cutting said at least one vegetable into lines, said cutting means (21) being located downstream from said holding means (9); and
thrust means (6) which are movable according to a predetermined direction (S), to push at least one vegetable through said holding means (9) against said cutting means (21);
wherein said thrust means (6), said holding means (9) and said cutting means (21) are substantially aligned along said predetermined direction (S); and
wherein said holding means (9) or said cutting means (21) are respectively movable in rotation relative to said cutting means (21) or said holding means (9), such that said cutting means (21) operate on said at least one vegetable, forming at least one substantially filiform vegetable portion when said thrust means (6) push, when in use, said at least one vegetable against said cutting means (21).

2. Machine according to claim 1, characterized in that said holding means (9) are movable in rotation relative to said cutting means (21).

3. Machine according to claim 2, characterized in that said thrust means (6) comprise a head (7) which is idle rotatable and comprises engaging means (8) configured to engage with said holding means (9) such that said head (6) passes through said holding means (9) and rotates together with said holding means (9) when said holding means (9) rotate.

4. Machine according to claim 1, characterized in that said holding means (9) comprise centering means (15) to center said at least one vegetable relative to said predetermined direction (S).

5. Machine according to claim 1, characterized in that it comprises orienting means (19) to orient an end portion of said at least one vegetable towards said cutting means (21).

6. Machine according to claim 5, characterized in that said orienting means comprise a plurality of arms (19) which are rotatable and elastic means connected with said plurality of arms (19) such as to push said plurality of arms (19) towards said at least one vegetable when said at least one vegetable is located in said holding means (9).

7. Machine according to claim 1, characterized in that a through cavity (14) is formed in said holding means (9), the through cavity (14) being directed according to said predetermined direction (S) and configured to receive said at least one vegetable, in that a plurality of openings (16) is formed in said holding means (9), the plurality of openings (16) being in communication with said through cavity (14), and in that said holding means comprise a plurality of holding elements (9) which are movable through said plurality of openings (16) such as to constrain, when in use, said at least one vegetable when said plurality of holding elements (9) is arranged through said plurality of openings (16).

8. Machine according to claim 7, characterized in that said holding means comprise elastic means connected with said plurality of holding elements (9) such as to push said plurality of holding elements (9) towards said at least one vegetable when said at least one vegetable is arranged in said holding means.

9. Machine according to claim 1, characterized in that it comprises a removing element (23) operating between said holding means (9) and said cutting means (21) such as to remove a portion of said at least one vegetable from a zone comprised between said holding means (9) and said cutting means (21) after cutting said at least one vegetable.

10. Machine according to claim 1, characterized in that it comprises a conveyor belt (3) where a plurality of housings or cups (4) for vegetables is defined, and a lifting system which is configured to operate on at least one portion (3′) of said conveyor belt (3) such as to bring at least one vegetable, which is arranged in a housing (3), in a position defined between said thrust means (6) and said holding means (9).

11. Machine according to claim 1, characterized in that said holding means (9) are fixed and in that said cutting means (21) are movable in rotation relative to said holding means (9).
